(19) United States
(12) Patent Application Publication
(10) Pub. No.: US 2024/0054992 A1
(43) Pub. Date: Feb. 15, 2024

(54) LABELING METHOD, LABELING DEVICE, AND LABELING PROGRAM

(71) Applicant: NIPPON TELEGRAPH AND TELEPHONE CORPORATION, Tokyo (JP)

(72) Inventor: Hiroki KANAGAWA, Tokyo (JP)

(73) Assignee: NIPPON TELEGRAPH AND TELEPHONE CORPORATION, Tokyo (JP)

(21) Appl. No.: 18/038,700

(22) PCT Filed: Nov. 25, 2020
(86) PCT No.: PCT/JP2020/043851

§ 371 Date: May 24, 2023

(51) Int. Cl. G10L 15/06

(52) U.S. Cl. CPC G10L 15/063

(57) ABSTRACT

A labeling processing device (100) generates first label information by labeling time information in a forward direction with respect to a plurality of phoneme boundaries set in speech information for learning. The labeling processing device (100) generates second label information by labeling time information in a direction opposite to the forward direction with respect to a plurality of phoneme boundaries set in speech information for learning and inverting the order of the labeled time information. The labeling processing device (100) detects whether phoneme boundaries are appropriate on the basis of a difference between time information on a plurality of phoneme boundaries included in the first label information and time information on a plurality of phoneme boundaries included in the second label information.

### TECHNICAL FIELD

The present invention relates to a labeling processing method, a labeling processing device, and a labeling processing program.

### BACKGROUND ART

Acoustic model construction of speech synthesis requires speech and a label corresponding to the speech. In speech synthesis based on a deep neural network (DNN), which is a mainstream in statistical parametric speech synthesis is recent years, it is necessary to accurately provide time information in order to associate frame-level language feature amounts and acoustic feature amounts between input and output of models. The work of providing time information corresponding to a phoneme is called phoneme labeling. In order to manually perform this, it is necessary to perform listening many times while comparing the speech with the phoneme label, which requires enormous time and cost.

As a method for automatically performing the phoneme labeling, a method using the hidden markov model (HMM) is often used (for example, Patent Literature 1 and Non Patent Literature 1). By providing the HMM with the acoustic feature amount and the phoneme label, it is possible to obtain a label with time information through a search algorithm. In main conventional methods, the gaussian mixture model (GMM) is used for acoustic likelihood calculation. However, in recent years, a method using the deep neural network (DNN) having higher discriminability than the GMM has been mainly used (for example, Non Patent Literatures 2 and 3).

### CITATION LIST

### Patent Literature

Patent Literature 1: JP 2004-077901 A

### Non Patent Literature

Non Patent Literature 1: Tsuyoshi Kawai, Tomoki Toda, “AN EVALUATION OF AUTOMATIC PHONEME SEGMENTATION FOR CONCATENATIVE SPEECH SYNTHESIS”, IEICE Technical Journal, SP2002-170, pp5-10, 2003

Non Patent Literature 2: G. Hinton, L. Deng, D. Yu, G. Dahl, A. Mohamed, N. Jaitly, A. Senior, V. Vanhoucke, P. Nguyen, T. Sainath, and B. Kingsbury, “Deep neural networks for acoustic modeling in speech recognition”, IEEE Signal Processing Magazine, Vol. 29 (6) , pp. 82-97, 2012.

Non Patent Literature 3: David Ayllon, Fernando Villavicencio, Pierre Lanchantin, “A Strategy for Improved Phone-Level Lyrics-to-Audio Alignment for Speech-to-Singing Synthesis”, Proc.Interspeech, pp. 2603-2607

### SUMMARY OF INVENTION

### Technical Problem

Labels obtained by automatic labeling including the aforementioned framework may result in phoneme boundaries that are far from those manually applied. In a case where such a label is used for learning of speech synthesis, when a sentence including a phoneme having a large labeling error is subjected to speech synthesis, speech of uttering a different phoneme is synthesized at an unintended timing.

In order to prevent this, it is preferable to manually correct all phoneme boundary positions of an automatic labeling result, but as described above, manually performing this operation requires enormous costs. Even if there is no correction portion, in order to detect the presence or absence of the correction portion, it is necessary to listen to speech of all labeling targets at least once, and it takes a lot of time.

The present invention has been made in view of the above, and an object of the present invention is to provide a labeling processing method, a labeling processing device, and a labeling processing program capable of detecting a labeling error.

### Solution to Problem

In order to solve the above-described problems and achieve the object, a labeling processing method according to the present invention includes: a forward labeling step of generating first label information by labeling time information in a forward direction with respect to a plurality of phoneme boundaries set in speech information for learning; a backward labeling step of generating second label information by labeling time information in a direction opposite to the forward direction with respect to the plurality of phoneme boundaries set in the speech information for learning and inverting an order of the time information that has been labeled; and a learning step of learning a model that detects whether the phoneme boundaries are appropriate on the basis of a difference between time information of a plurality of phoneme boundaries included in the first label information and time information of a plurality of phoneme boundaries included in the second label information.

### Advantageous Effects of Invention

According to the present invention, a labeling error can be detected.

### BRIEF DESCRIPTION OF DRAWINGS

FIG. 1 is a functional block diagram illustrating a configuration of a labeling processing device according to a first embodiment.

FIG. 2 is a diagram illustrating a configuration of a forward labeling unit according to the first embodiment.

FIG. 3 is a diagram illustrating a configuration of a backward labeling unit according to the first embodiment.

FIG. 4 is a diagram illustrating a configuration of a learning unit according to the first embodiment.

FIG. 5 is a diagram for explaining processing of a phoneme boundary difference calculation unit.

FIG. 6 is a diagram illustrating a configuration of a detection unit according to the first embodiment.

FIG. 7 is a flowchart illustrating a processing procedure at the time of learning of the labeling processing device according to the first embodiment.

FIG. 8 is a flowchart illustrating a processing procedure at the time of detection of the labeling processing device according to the first embodiment.

FIG. 9 is a functional block diagram illustrating a configuration of a labeling processing device according to a second embodiment.

FIG. 10 is a diagram illustrating a configuration of a learning unit according to the second embodiment.

FIG. 11 is a diagram illustrating a configuration of a detection unit according to the second embodiment.

FIG. 12 is a functional block diagram illustrating a configuration of a labeling processing device according to a third embodiment.

FIG. 13 is a diagram illustrating a configuration of a learning unit according to the third embodiment.

FIG. 14 is a diagram illustrating an example of a computer that executes a labeling processing program.

### DESCRIPTION OF EMBODIMENTS

Hereinafter, embodiments of a labeling processing method, a labeling processing device, and a labeling processing program disclosed in the present application will be described in detail with reference to the drawings. Note that the present invention is not limited by the embodiments.

### EXAMPLE 1

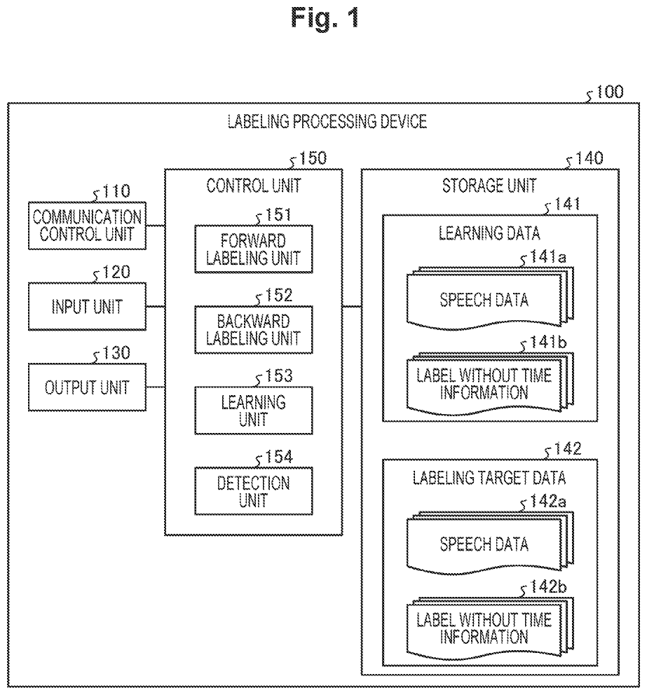

First, a configuration example of a labeling processing device according to a first embodiment will be described. FIG. 1 is a functional block diagram illustrating a configuration of the labeling processing device according to the first embodiment. As illustrated in FIG. 1, a labeling processing device 100 includes a communication control unit 110, an input unit 120, an output unit 130, a storage unit 140, and a control unit 150.

The communication control unit 110 is realized by a network interface card (NIC) or the like, and controls communication between an external apparatus and the control unit 150 via a telecommunication line such as a local area network (LAN) or the Internet.

The input unit 120 is realized by using an input device such as a keyboard or a mouse, and inputs various kinds of instruction information such as a processing start to the control unit 150 in response to input operations of an operator.

The output unit 130 is an output device that outputs information acquired from the control unit 150, and is realized by a display device such as a liquid crystal display, a printing device such as a printer, or the like.

The storage unit 140 includes learning data 141 and labeling target data 142. The storage unit 140 is realized by a semiconductor memory element such as a random access memory (RAM) or a flash memory or a storage device such as a hard disk or an optical disk.

The learning data 141 includes speech data (a plurality of pieces of speech data) 141a and a label without time information (a plurality of labels without time information) 141b. Each piece of speech data 141a and each label without time information 141b are associated with each other. For example, the speech data 141a is speech data corresponding to a WAV file or the like. The label without time information 141b is information indicating the type of phonemes included in the speech data 141a and an interval of the corresponding phonemes. A phoneme interval is indicated by a phoneme boundary. It is assumed that time information is not set at the phoneme boundary of the label without time information 141b.

The learning data 141 is used in processing at the time of learning by the control unit 150 described later.

The labeling target data 142 includes speech data (a plurality of pieces of speech data) 142a and a label without time information (a plurality of labels without time information) 142b. Each piece of speech data 142a and each label without time information 142b are associated with each other. For example, the speech data 142a is speech data corresponding to a WAV file or the like. The label without time information 142b is information indicating the type of phonemes included in the speech data 142a and an interval of the corresponding phonemes. A phoneme interval is indicated by a phoneme boundary. It is assumed that time information is not set at the phoneme boundary of the label without time information 142b.

The labeling target data 142 is used in processing at the time of detection by the control unit 150 described later.

The control unit 150 includes a forward labeling unit 151, a backward labeling unit 152, a learning unit 153, and a detection unit 154. The control unit 150 corresponds to a central processing unit (CPU) or the like.

First, after describing processing at the time of learning performed by the control unit 150, processing at the time of detection performed by the control unit 150 will be described.

At the time of learning, the forward labeling unit 151, the backward labeling unit 152, and the learning unit 153 of the control unit 150 operate. Processing of the forward labeling unit 151, the backward labeling unit 152, and the learning unit 153 at the time of learning will be sequentially described.

At the time of learning, the forward labeling unit 151 labels time information in the forward direction (time-series direction) with respect to a plurality of phoneme boundaries on the basis of the speech data 141a and the label without time information 141b, thereby generating a label with time information. In the following description, a timed label generated by the forward labeling unit 151 on the basis of the speech data 141a and the label without time information 141b is referred to as a “first label with time information” as appropriate. The forward labeling unit 151 outputs a first label with time information to the learning unit 153.

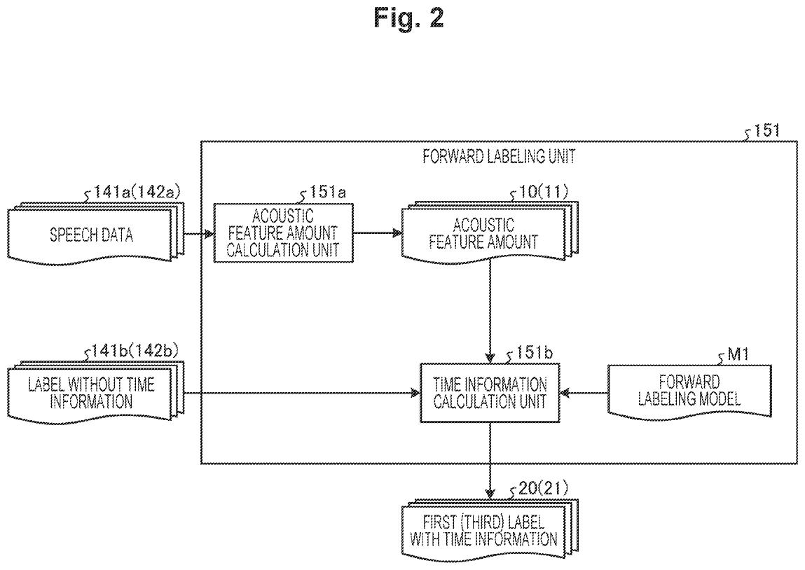

FIG. 2 is a diagram illustrating a configuration of the forward labeling unit according to the first embodiment. As illustrated in FIG. 2, the forward labeling unit 151 includes an acoustic feature amount calculation unit 151a and a time information calculation unit 151b.

The acoustic feature amount calculation unit 151a calculates the acoustic feature amount 10 from the speech data 141a at the time of learning. The acoustic feature amount 10 corresponds to mel-frequency cepstrum coefficients (MFCC), a mel-filter bank, and the like indicating frequency characteristics of speech. As the acoustic feature amount 10, other spectrograms, bolt neck feature amount obtained from DNN for speech recognition, or the like may be used.

The time information calculation unit 151b reads the forward labeling model M1 and inputs the acoustic feature amount 10 and the label without time information 141b to the forward labeling model M1 to calculate the first label with time information 20.

The forward labeling model M1 corresponds to a gaussian mixture model (GMM)-HMM or a DNN-HMM. In order to provide time information with higher accuracy, a hidden semi markov model (HSMM) in which a duration is explicitly modeled may be used instead of the HMM. The time information calculation unit 151b calculates the first label with time information 20 by performing forced alignment on the Viterbi algorithm. The first label with time information 20 is information in which time information is provided to each phoneme boundary of the label without time information 141b.

The forward labeling model M1 is a model learned by assigning an acoustic feature amount for learning and a label without time information to an input and assigning a label with time information for learning to an output.

At the time of learning, the backward labeling unit 152 generates a label with time information by labeling time information in a direction opposite to the forward direction on the basis of the speech data 141a and the label without time information 141b and inverting the order of the labeled time information. In the following description, a timed label generated by the backward labeling unit 152 on the basis of the speech data 141a and the label without time information 141b is referred to as a “second label with time information” as appropriate. The backward labeling unit 152 outputs a second label with time information to the learning unit 153.

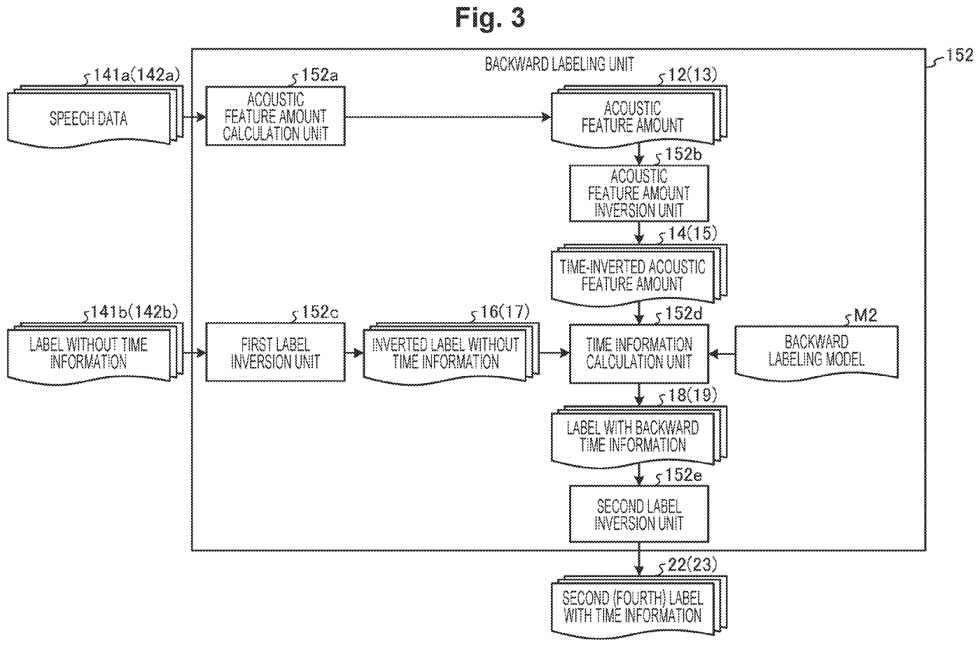

FIG. 3 is a diagram illustrating a configuration of a backward labeling unit according to the first embodiment. As illustrated in FIG. 3, the backward labeling unit 152 includes an acoustic feature amount calculation unit 152a, an acoustic feature amount inversion unit 152b, a first label inversion unit 152c, a time information calculation unit 152d, and a second label inversion unit 152e.

The acoustic feature amount calculation unit 152a calculates the acoustic feature amount 12 from the speech data 141a at the time of learning. The description of the acoustic feature amount 12 is similar to the description of the acoustic feature amount 10 described above.

The acoustic feature amount inversion unit 152b generates the time-inverted acoustic feature amount 14 by time-inverting the acoustic feature amount 12.

The first label inversion unit 152c generates the inverted label without time information 16 by inverting the type of phonemes and the order of phoneme boundaries included in the label without time information 141b. For example, it is assumed that a phoneme (a phoneme type) “ohayoo” corresponding to “Good morning” is included in the label without time information 141b. In this case, the first label inversion unit 152c generates the phoneme “ooyaho” as the inverted label without time information 16.

The time information calculation unit 152d reads the backward labeling model M2 and inputs the time-inverted acoustic feature amount 14 and the inverted label without time information 16 to the backward labeling model M2 to calculate the label with backward time information 18. The label with backward time information 18 is information in which time information is provided to each phoneme boundary of the inverted label without time information 16.

Here, the backward labeling model M2 is learned by inverting the input and output sequence of the forward labeling model M1 with respect to the time sequence, and such learning is achieved by assigning the time-inverted acoustic feature amount and the time-inverted label with time information to the input and output.

The second label inversion unit 152e generates the second label without time information 22 by inverting the type of phonemes included in the label with backward time information 18 and the time information provided to the phoneme boundaries.

The description returns to FIG. 1. The learning unit 153 learns a labeling error detection model that detects whether phoneme boundaries are appropriate on the basis of a difference between time information on a plurality of phoneme boundaries included in the first label with time information 20 and a plurality of phoneme boundaries included in the second label with time information 22.

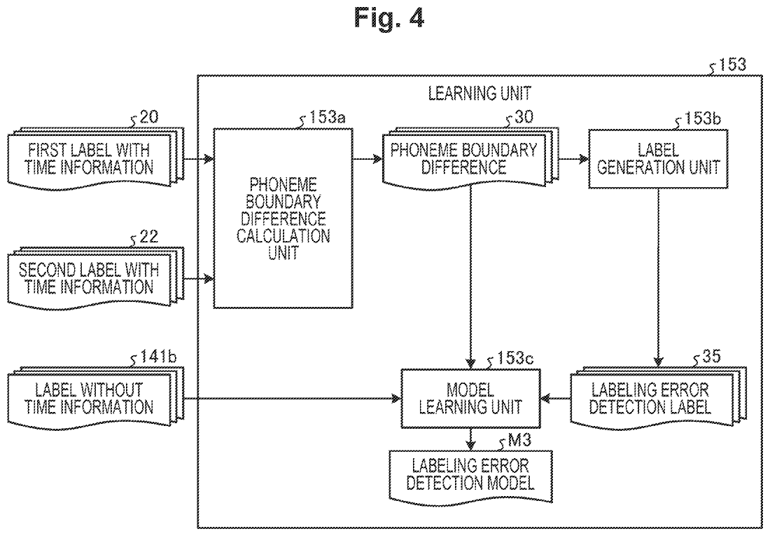

FIG. 4 is a diagram illustrating a configuration of a learning unit according to the first embodiment. As illustrated in FIG. 4, the learning unit 153 includes a phoneme boundary difference calculation unit 153a, a label generation unit 153b, and a model learning unit 153c.

The phoneme boundary difference calculation unit 153a calculates a difference (phoneme boundary difference 30) between time information on a plurality of phoneme boundaries included in the first label with time information 20 and a plurality of phoneme boundaries included in the second label with time information 22.

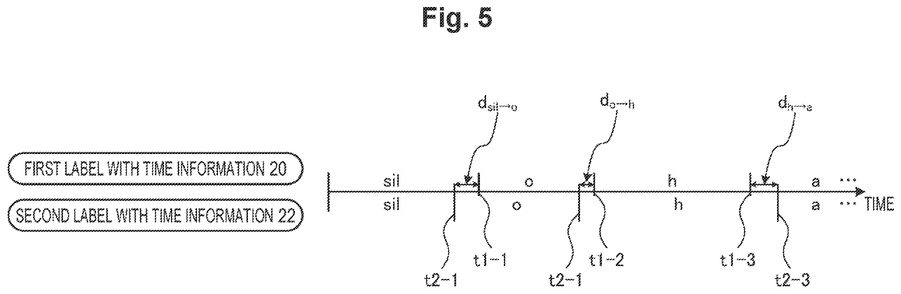

FIG. 5 is a diagram for explaining processing of a phoneme boundary difference calculation unit. It is assumed that the first label with time information 20 and the second label with time information 22 have phoneme types “sil”, “o”, “h”, “a”, “y”, “o”, “o”, and “sil”. “sil” is a phoneme indicating silence. The horizontal axis in FIG. 5 represents time.

For example, the time at the phoneme boundary between “sil” and “o” of the first label with time information 20 is “t1-1”. The time at the phoneme boundary between “o” and “h” of the first label with time information 20 is “t1-2”. The time at the phoneme boundary between “h” and “a” of the first label with time information 20 is “t1-3”.

For example, the time at the phoneme boundary between “sil” and “o” of the second label with time information 22 is “t2-1”. The time at the phoneme boundary between “o” and “h” of the second label with time information 22 is “t2-2”. The time at the phoneme boundary between “h” and “a” of the second label with time information 22 is “t2-3”.

The phoneme boundary difference calculation unit 153a calculates, in order from the first, a difference d between time at the phoneme boundary of the first label with time information 20 and time at the phoneme boundary of the first label with time information 20. In the example illustrated in FIG. 5, the phoneme boundary difference calculation unit 153a calculates a difference d_{sil→o} at the boundary where the phoneme changes from “sil” to “o” by the absolute value of the difference between the time t1-1 and the time t2-1.

The phoneme boundary difference calculation unit 153a calculates a difference d_{o→h} at the boundary where the phoneme changes from “o” to “h” by the absolute value of the difference between the time t1-2 and the time t2-2. The phoneme boundary difference calculation unit 153a calculates a difference d_{h→a} at the boundary where the phoneme changes from “h” to “a” by the absolute value of the difference between the time t1-3 and the time t2-3.

Although not illustrated in FIG. 5, the phoneme boundary difference calculation unit 153a calculates the phoneme boundary difference 30 by calculating a difference d of another phoneme boundary. The phoneme boundary difference 30 includes each difference d.

The description returns to FIG. 4. The label generation unit 153b determines whether the position of the phoneme boundary is appropriate for each phoneme boundary on the basis of the phoneme boundary difference 30, and provides a binary determination result to each phoneme boundary on the basis of the determination result, thereby generating the labeling error detection label 35. For example, the label generation unit 153b provides “1” to the phoneme boundary when the position of the phoneme boundary is appropriate, and provides “0” to the phoneme boundary when the position of the phoneme boundary is not appropriate.

The label generation unit 153b refers to the difference d of each phoneme boundary included in the phoneme boundary difference 30, and in a case where the difference d is equal to or smaller than a preset threshold thd, the label generation unit 153b determines that the position of the phoneme boundary is appropriate, and provides the label “1” to the phoneme boundary. On the other hand, in a case where the difference d is larger than a preset threshold thd, the label generation unit 153b determines that the position of the phoneme boundary is not appropriate, and provides the label “0” to the corresponding phoneme boundary.

An example of processing of the label generation unit 153b will be described with reference to FIG. 5. For example, in a case where the difference d_{o→h} is equal to or smaller than the threshold thd, the label generation unit 153b determines that the position of the phoneme boundary between the phoneme “o” and the phoneme “h” is appropriate, and provides the label “1” to the phoneme boundary between the phoneme “o” and the phoneme “h”.

In a case where the difference d_{h→a} is larger than the threshold thd, the label generation unit 153b determines that the position of the phoneme boundary between the phoneme “h” and the phoneme “a” is not appropriate, and provides the label “0” to the phoneme boundary between the phoneme “h” and the phoneme “a”.

The label generation unit 153b generates the labeling error detection label 35 by repeatedly performing the above processing with respect to the difference d of each phoneme boundary.

Here, the threshold thd is set for each phoneme boundary or each phoneme type so as not to adversely affect the speech synthesis in a case where the label with time information is used as the learning data of the speech synthesis model. For example, since the boundary between phonemes of long vowels is originally ambiguous, the threshold thd may be set to be large. On the other hand, the threshold thd is set small for the boundary between a short phoneme such as the explosive sound and another phoneme. That is, the threshold of the phoneme boundary between the long vowels is made larger than the threshold of the phoneme boundary related to the phoneme of the explosive sound.

In a case where any one of the plurality of differences d included in the phoneme boundary difference 30, the phoneme boundary difference 30 corresponding to one label without time information 141b, is larger than the threshold thd, the label generation unit 153b may set the label “0” to the one label without time information 141b. The label generation unit 153b may set the label “1” to one label without time information 141b in a case where all the plurality of differences d included in the phoneme boundary difference 30, the phoneme boundary difference 30 corresponding to the one label without time information 141b, is equal or smaller than the threshold thd.

The model learning unit 153c performs learning of a labeling error detection model M3 on the basis of the phoneme boundary difference 30, the label without time information 141b, and the labeling error detection label 35. For example, the labeling error detection model M3 may be used as the DNN or another learning model may be used.

The model learning unit 153c uses the phoneme boundary difference 30 and the phoneme boundary of the label without time information 141b as input data, uses the binary value set for each phoneme boundary specified from the labeling error detection label 35 as a correct answer label, and learns the parameters of the labeling error detection model M3 by back propagation.

For example, the model learning unit 153c learns the parameters of the labeling error detection model M3 that minimizes the cross entropy shown in Equation (1). In Equation (1), “0” is an input vector obtained from the phoneme boundary difference 31 and the phoneme boundary of the label without time information 142b. P(lᵢ|0) is a probability of the label lᵢ when an input vector is provided. P(l₁|0) is a probability of the label l₁ when an input vector is provided. For example, the label l₁ corresponds to the label “1”, and the label l₀ corresponds to the label “1”.

$$[ Equation 1 ]$$

$$loss ( O , {l}_{i} ) = - log ( \frac{exp ( P ( {l}_{i} \vert O ) )}{exp ( P ( {l}_{1} \vert O ) ) + exp ( {l}_{0} \vert O )} ) \qquad ( 1 )$$

When the input data is input to the labeling error detection model M3, the first probability value indicating that the position of the phoneme boundary is appropriate and the second probability value indicating that the position of the phoneme boundary is not appropriate are output. In a case where the first probability value is larger than the second probability value, it is determined that the position of the phoneme boundary is appropriate. On the other hand, in a case where the second probability value is larger than the first probability value, it is determined that the position of the phoneme boundary is not appropriate, and manual check becomes necessary.

As described above, at the time of learning, the forward labeling unit 151, the backward labeling unit 152, and the learning unit 153 of the control unit 150 operate, and thereby, the learning of the labeling error detection model M3 ends.

Returning to the description of FIG. 1, processing at the time of detection performed by the control unit 150 will be described. At the time of detection, the forward labeling unit 151, the backward labeling unit 152, and the detection unit 154 of the control unit 150 operate. Processing of the forward labeling unit 151, the backward labeling unit 152, and the detection unit 154 at the time of detection will be sequentially described.

At the time of detection, the forward labeling unit 151 labels time information in the forward direction (time-series direction) with respect to a plurality of phoneme boundaries on the basis of the speech data 142a and the label without time information 142b, thereby generating a label with time information. In the following description, a timed label generated by the forward labeling unit 151 on the basis of the speech data 142a and the label without time information 142b is referred to as a “third label with time information” as appropriate. The forward labeling unit 151 outputs a third label with time information to the detection unit 154.

Processing of the forward labeling unit 151 at the time of detection will be described with reference to FIG. 2.

The acoustic feature amount calculation unit 151a calculates the acoustic feature amount 11 from the speech data 142a at the time of detection.

The time information calculation unit 151b reads the forward labeling model M1 and inputs the acoustic feature amount 11 and the label without time information 142b to the forward labeling model M1 to calculate the third label with time information 21.

At the time of detection, the backward labeling unit 152 generates a label with time information by labeling time information in a direction opposite to the forward direction on the basis of the speech data 142a and the label without time information 142b and inverting the order of the labeled time information. In the following description, a timed label generated by the backward labeling unit 152 on the basis of the speech data 142a and the label without time information 142b is referred to as a “fourth label with time information” as appropriate. The backward labeling unit 152 outputs a fourth label with time information to the detection unit 154.

Processing of the backward labeling unit 152 at the time of detection will be described with reference to FIG. 3.

The acoustic feature amount calculation unit 152a calculates the acoustic feature amount 13 from the speech data 142a at the time of detection.

The acoustic feature amount inversion unit 152b generates the time-inverted acoustic feature amount 15 by time-inverting the acoustic feature amount 13.

The first label inversion unit 152c generates the inverted label without time information 17 by inverting the type of phonemes and the order of phoneme boundaries included in the label without time information 142b.

The time information calculation unit 152d reads the backward labeling model M2 and inputs the time-inverted acoustic feature amount 15 and the inverted label without time information 17 to the backward labeling model M2 to calculate the label with backward time information 19.

The second label inversion unit 152e generates the fourth label with time information 23 by inverting the type of phonemes included in the label with backward time information 19 and the time information provided to the phoneme boundaries.

The description returns to FIG. 1. The detection unit 154 calculates a difference between time information on a plurality of phoneme boundaries included in the third label with time information 21 and a plurality of phoneme boundaries included in the fourth label with time information 23. The detection unit 154 inputs the input data based on the calculated difference and the label without time information 142b to the labeling error detection model M3, and determines whether the position of the phoneme boundary included in the label without time information 142b is appropriate.

The detection unit 154 repeatedly performs the above processing and classifies the plurality of labels without time information 142b into a group in which the position of the phoneme boundary is appropriate and a group in which the position of the phoneme boundary is not appropriate. The label without time information 142b that has been classified into a group in which the position of the phoneme boundary is not appropriate is a target whose position of the phoneme boundary is to be checked manually.

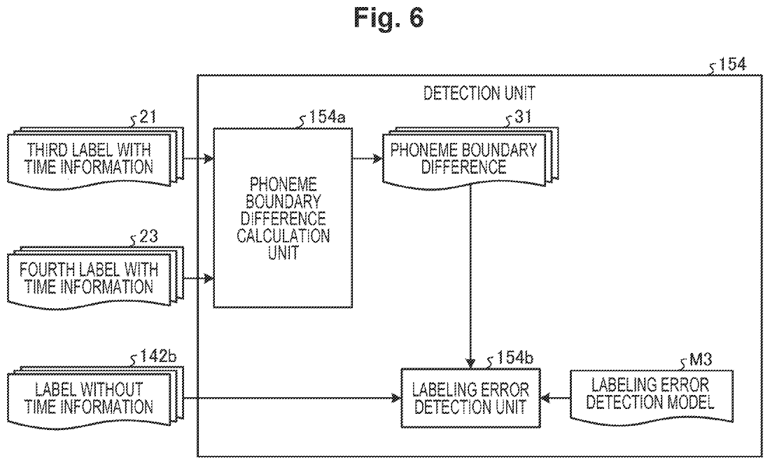

FIG. 6 is a diagram illustrating a configuration of a detection unit according to the first embodiment. As illustrated in FIG. 6, the detection unit 154 includes a phoneme boundary difference calculation unit 154a and a labeling error detection unit 154b.

The phoneme boundary difference calculation unit 154a calculates a difference (phoneme boundary difference 31) between time information on a plurality of phoneme boundaries included in the third label with time information 21 and a plurality of phoneme boundaries included in the fourth label with time information 23. The processing of the phoneme boundary difference calculation unit 154a corresponds to the processing of the phoneme boundary difference calculation unit 153a.

The labeling error detection unit 154b reads the labeling error detection model M3 learned by the learning unit 153. The labeling error detection unit 154b uses the phoneme boundary difference 31 and the phoneme boundary of the label without time information 142b as input data, and inputs the input data to the labeling error detection model M3.

The labeling error detection unit 154b inputs the input data to the labeling error detection model M3 to output the first probability value indicating that the position of the phoneme boundary is appropriate and the second probability value indicating that the position of the phoneme boundary is not appropriate are output. When the first probability value is larger than the second probability value, the labeling error detection unit 154b classifies the label without time information 142b into a group in which the position of the phoneme boundary is appropriate.

On the other hand, when the second probability value is larger than the first probability value, the labeling error detection unit 154b classifies the label without time information 142b into a group in which the position of the phoneme boundary is not appropriate.

As described above, when the forward labeling unit 151, the backward labeling unit 152, and the detection unit 154 of the control unit 150 operate at the time of detection, the plurality of labels without time information 142b are classified into a group in which the position of the phoneme boundary is appropriate and a group in which the position of the phoneme boundary is not appropriate. The detection unit 154 may output the detection result to the output unit 130.

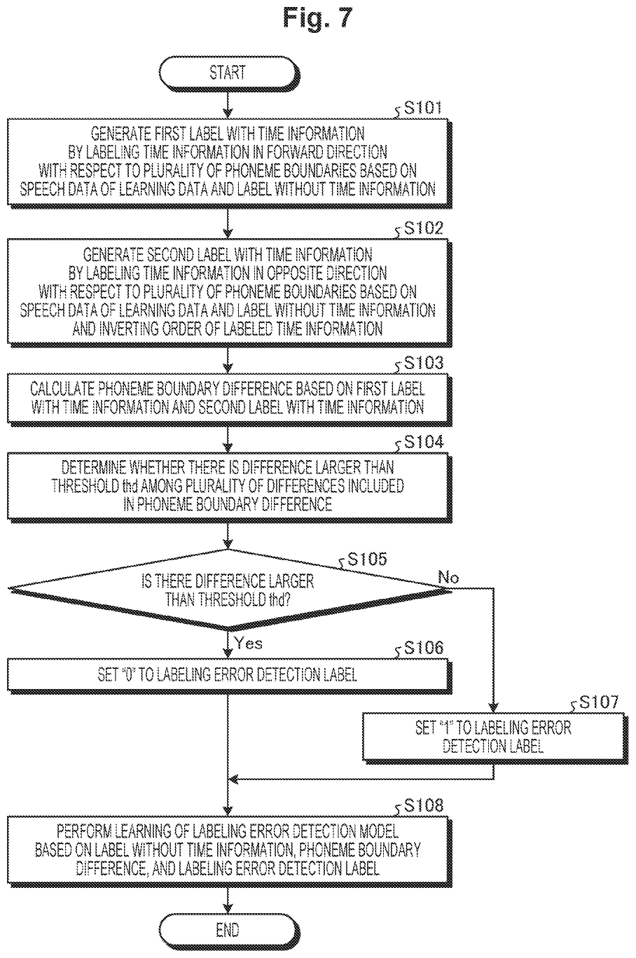

Next, an example of a processing procedure of the labeling processing device 100 according to the first embodiment will be described. FIG. 7 is a flowchart illustrating a processing procedure at the time of learning of the labeling processing device according to the first embodiment. As illustrated in FIG. 7, the forward labeling unit 151 of the labeling processing device 100 labels time information in the forward direction with respect to a plurality of phoneme boundaries on the basis of the speech data 141a of the learning data 141 and the label without time information 141b, thereby generating a first label with time information 20 (step S101).

The backward labeling unit 152 of the labeling processing device 100 labels time information in the backward direction with respect to a plurality of phoneme boundaries on the basis of the speech data 141a of the learning data 141 and the label without time information 141b, inverts the order of the labeled time information, and thereby generating a second label with time information 22 (step S102).

The learning unit 153 (phoneme boundary difference calculation unit 153a) of the labeling processing device 100 calculates the phoneme boundary difference 30 on the basis of the first label with time information 20 and the second label with time information 22 (step S103).

The label generation unit 153b of the learning unit 153 determines whether there is a difference larger than the threshold thd among the plurality of differences included is the phoneme boundary difference 30 (step S104). If there is a difference larger than the threshold thd (step S105, Yes), the label generation unit 153b sets “0 (not appropriate)” in the labeling error detection label 35 (step S106).

If there is no difference larger than the threshold thd (step S105, No), the label generation unit 153b sets “1 (appropriate)” is the labeling error detection label 35 (step S107).

The model learning unit 153c of the learning unit 153 performs learning of the labeling error detection model M3 on the basis of the label without time information 141b, the phoneme boundary difference 30, and the labeling error detection label 35 (step S108).

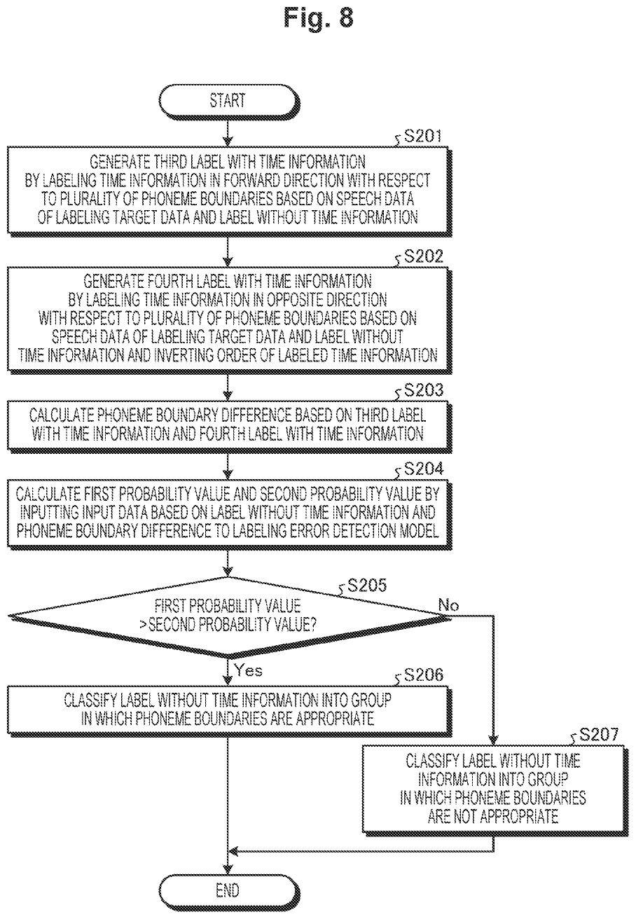

FIG. 8 is a flowchart illustrating a processing procedure at the time of detection of the labeling processing device according to the first embodiment. As illustrated in FIG. 8, the forward labeling unit 151 of the labeling processing device 100 labels time information in the forward direction with respect to a plurality of phoneme boundaries on the basis of the speech data 142a of the labeling target data 142 and the label without time information 142b, thereby generating a third label with time information 21 (step S201).

The backward labeling unit 152 of the labeling processing device 100 labels time information in the backward direction with respect to a plurality of phoneme boundaries on the basis of the speech data 142a of the labeling target data 142 and the label without time information 142b, inverts the order of the labeled time information, and thereby generating a fourth label with time information 23 (step S202).

The detection unit 154 (phoneme boundary difference calculation unit 154a) of the labeling processing device 100 calculates the phoneme boundary difference 31 on the basis of the third label with time information 21 and the fourth label with time information 23 (step S203).

The labeling error detection unit 154b of the detection unit 154 inputs the input data based on the label without time information 142b and the phoneme boundary difference 31 to the labeling error detection model M3, and calculates a first probability value and a second probability value (step S204).

When the first probability value is larger than the second probability value (step S205, Yes), the labeling error detection unit 154b classifies the label without time information 142b into a group in which phoneme boundaries are appropriate (step S206).

On the other hand, when the first probability value is not larger than the second probability value (step S205, No), the labeling error detection unit 154b classifies the label without time information 142b into a group in which phoneme boundaries are not appropriate (step S207).

Next, effects of the labeling processing device 100 according to the first embodiment will be described. At the time of learning, the labeling processing device 100 generates the first label with time information 20 by labeling the time information in the forward direction with respect to the plurality of phoneme boundaries, and generates a second label with time information 22 by labeling the time information in the backward direction with respect to a plurality of phoneme boundaries and inverting the order of the labeled time information. The labeling processing device 100 learns a labeling error detection model M3 that detects whether a phoneme boundary is appropriate on the basis of a difference between time information on a plurality of phoneme boundaries included in the first label with time information 20 and a plurality of phoneme boundaries included in the second label with time information 22. As a result, it is possible to obtain the labeling error detection model M3 that can automatically detect whether the phoneme boundary is appropriate.

At the time of detection, the labeling processing device 100 generates the third label with time information 21 by labeling the time information in the forward direction with respect to the plurality of phoneme boundaries, and generates a fourth label with time information 23 by labeling the time information in the backward direction with respect to a plurality of phoneme boundaries and inverting the order of the labeled time information. The labeling processing device 100 detects whether a phoneme boundary is appropriate on the basis of a difference between time information on a plurality of phoneme boundaries included in the third label with time information 21 and a plurality of phoneme boundaries included in the fourth label with time information 23, and the labeling error detection model M3. As a result, it is possible to automatically detect whether the phoneme boundary included in the label without time information 142b is appropriate (it is possible to detect a labeling error).

### EXAMPLE 2

In the first embodiment described above, in the labeling error detection model M3, the one with a higher probability is simply adopted among the binary probabilities predicted by the statistical model. However, since the forward and backward automatic labeling models can be labeled with time information with a certain degree of accuracy, the labeling error detection label that is the learning data of the labeling error detection model is mostly provided with the label “1” indicating that it is appropriate (manually check is not necessary).

Then, due to the nature of the statistical model, the labeling error detection model M3 is likely to provide a high value to the “first probability value (probability value indicating that the position of the phoneme boundary is appropriate)” having a large amount of learning data, and even if a phoneme boundary difference that needs to be manually checked at the time of error label detection is input, the labeling error detection model M3 erroneously detects the phoneme boundary difference as “appropriate (manual check is not necessary)”. In the second embodiment, by introducing the prior probability into the learning unit and the detection unit, the problem of the balance of the amount of learning data can be reduced.

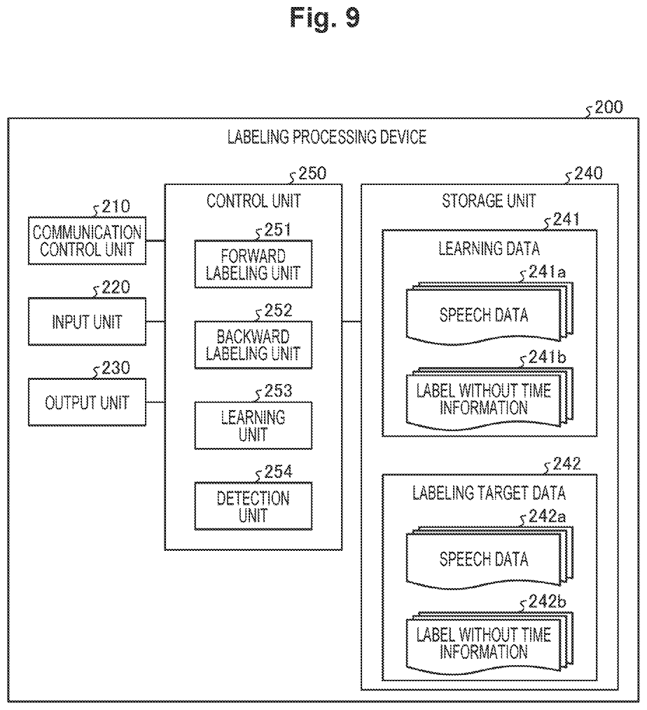

FIG. 9 is a functional block diagram illustrating a configuration of a labeling processing device according to the second embodiment. As illustrated in FIG. 9, a labeling processing device 200 includes a communication control unit 210, an input unit 220, an output unit 230, a storage unit 240, and a control unit 250.

The description regarding the communication control unit 210, the input unit 220, and the output unit 230 is similar to the description regarding the communication control unit 110, the input unit 120, and the output unit 130 described in the first embodiment.

The storage unit 240 includes learning data 241 and labeling target data 242. Here, the storage unit 240 is achieved by, for example, a semiconductor memory element such as a RAM or a flash memory, or a memory device such as a hard disk or an optical disk.

The learning data 241 includes speech data (a plurality of pieces of speech data) 241a and a label without time information (a plurality of labels without time information) 241b. The description of the speech data 241a and the label without time information 241b is similar to the description of the speech data 141a and the label without time information 141b described in the first embodiment.

The learning data 241 is used in processing at the time of learning by the control unit 250 described later.

The labeling target data 242 includes speech data (a plurality of pieces of speech data) 242a and a label without time information (a plurality of labels without time information) 242b. The description of the speech data 242a and the label without time information 242b is similar to the description of the speech data 142a and the label without time information 142b described in the first embodiment.

The labeling target data 242 is used in processing at the time of detection by the control unit 250 described later.

The control unit 250 includes a forward labeling unit 251, a backward labeling unit 252, a learning unit 253, and a detection unit 254. The control unit 250 corresponds to a CPU or the like.

First, after describing processing at the time of learning performed by the control unit 250, processing at the time of detection performed by the control unit 250 will be described.

At the time of learning, the forward labeling unit 251, the backward labeling unit 252, and the learning unit 253 of the control unit 250 operate. Processing of the forward labeling unit 251, the backward labeling unit 252, and the learning unit 253 at the time of learning will be sequentially described.

The processing of the forward labeling unit 251 and the backward labeling unit 252 at the time of learning is similar to the processing of the forward labeling unit 151 and the backward labeling unit 152 at the time of learning described in the first embodiment. The forward labeling unit 251 outputs a first label with time information 20 to the learning unit 253. The backward labeling unit 252 outputs a second label with time information 22 to the learning unit 253.

The learning unit 253 learns a labeling error detection model that detects whether a phoneme boundary is appropriate on the basis of a difference between time information on a plurality of phoneme boundaries included in the first label with time information 20 and a plurality of phoneme boundaries included in the second label with time information 22.

The learning unit 253 calculates a “prior probability” from a frequency at which “1 (manual check is not necessary)” is provided to the labeling error detection label and a frequency at which “0 (manual check is necessary)” is provided, by using the labeling error detection label used when learning the labeling error detection model.

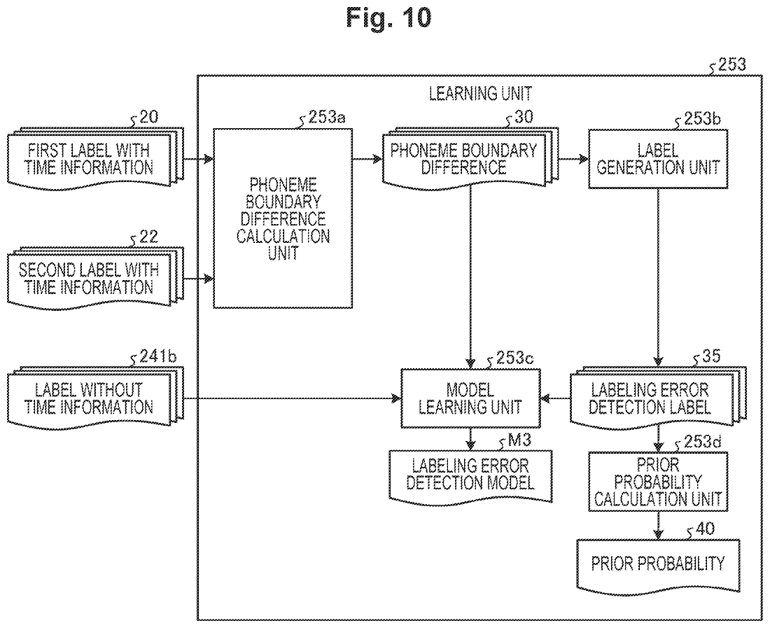

FIG. 10 is a diagram illustrating a configuration of a learning unit according to the second embodiment. As illustrated in FIG. 10, the learning unit 253 includes a phoneme boundary difference calculation unit 253a, a label generation unit 253b, a model learning unit 253c, and a prior probability calculation unit 253d.

The phoneme boundary difference calculation unit 253a calculates a difference (phoneme boundary difference 30) between time information on a plurality of phoneme boundaries included in the first label with time information 20 and a plurality of phoneme boundaries included in the second label with time information 22. Other descriptions of the phoneme boundary difference calculation unit 253a are similar to those of the phoneme boundary difference calculation unit 153a described in the first embodiment.

The label generation unit 253b determines whether the position of the phoneme boundary is appropriate for each phoneme boundary on the basis of the phoneme boundary difference 30, and provides a binary determination result to each phoneme boundary on the basis of the determination result, thereby generating the labeling error detection label 35. For example, the label generation unit 253b provides the label “1” to the phoneme boundary when the position of the phoneme boundary is appropriate, and provides the label “0” to the phoneme boundary when the position of the phoneme boundary is not appropriate. Other descriptions of the label generation unit 253b are similar to those of the label generation unit 153b described in the first embodiment.

The model learning unit 253c performs learning of a labeling error detection model M3 on the basis of the phoneme boundary difference 30, the label without time information 241b, and the labeling error detection label 35. Other descriptions of the model learning unit 253c are similar to those of the model learning unit 153c described in the first embodiment.

The prior probability calculation unit 253d calculates a prior probability 40 on the basis of an appearance frequencies of the labels “1” and “0” provided to the labeling error detection label 35. For example, the prior probability calculation unit 253d calculates the prior probability 40 on the basis of Equation (2).

$$[ Equation 2 ]$$

$$P ( {l}_{i} ) = \frac{{M}_{i}}{N} \qquad ( 2 )$$

In Equation (2), P(lᵢ) indicates the prior probability of the label lᵢ. For example, the label l₁ corresponds to the label “1”, and the label l₀ corresponds to the label “1”. Mᵢ indicates an amount of data of the label lᵢ. For example, M₁ corresponds to the number of phoneme boundaries to which the label “1” is provided in the labeling error detection label 35. M₀ corresponds to the number of phoneme boundaries to which the label “0” is provided in the labeling error detection label 35. N corresponds to the total amount of data. For example, N corresponds to the number of phoneme boundaries to which the label is provided in the labeling error detection label 35.

As described above, at the time of learning, the forward labeling unit 251, the backward labeling unit 252, and the learning unit 253 of the control unit 250 operate, and thereby, the learning of the labeling error detection model M3 ends. In addition, the calculation of the prior probability 40 also ends.

Subsequently, processing at the time of detection performed by the control unit 250 will be described. At the time of detection, the forward labeling unit 251, the backward labeling unit 252, and the detection unit 254 of the control unit 250 operate. Processing of the forward labeling unit 251, the backward labeling unit 252, and the detection unit 254 at the time of detection will be sequentially described.

The processing of the forward labeling unit 251 and the backward labeling unit 252 at the time of detection is similar to the processing of the forward labeling unit 151 and the backward labeling unit 152 at the time of learning described in the first embodiment. The forward labeling unit 251 outputs a third label with time information 21 to the detection unit 254. The backward labeling unit 252 outputs a fourth label with time information 23 to the detection unit 254.

The detection unit 254 calculates a difference between time information on a plurality of phoneme boundaries included in the third label with time information 21 and a plurality of phoneme boundaries included in the fourth label with time information 23. The detection unit 254 inputs the input data based on the calculated difference and the label without time information 142b to the labeling error detection model M3, corrects the first probability and the second probability output from the labeling error detection model M3 with the prior probability, and determines whether the position of the phoneme boundary included in the label without time information 242b is appropriate.

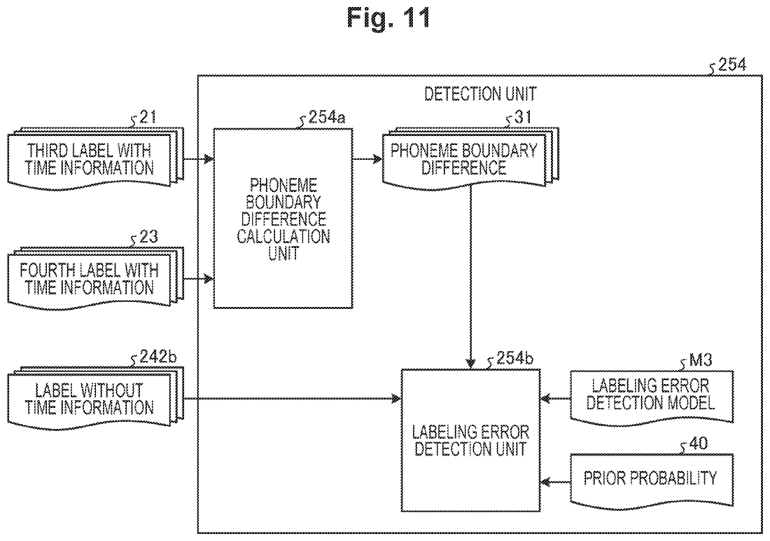

FIG. 11 is a diagram illustrating a configuration of a detection unit according to the second embodiment. As illustrated in FIG. 11, the detection unit 254 includes a phoneme boundary difference calculation unit 254a and a labeling error detection unit 254b.

The phoneme boundary difference calculation unit 254a calculates a difference (phoneme boundary difference 31) between time information on a plurality of phoneme boundaries included in the third label with time information 21 and a plurality of phoneme boundaries included in the fourth label with time information 23. The processing of the phoneme boundary difference calculation unit 254a corresponds to the processing of the phoneme boundary difference calculation unit 253a.

The labeling error detection unit 254b reads the labeling error detection model M3 learned by the learning unit 253. The labeling error detection unit 254b uses the phoneme boundary difference 31 and the phoneme boundary of the label without time information 242b as input data, and inputs the input data to the labeling error detection model M3. The labeling error detection unit 254b corrects the probability value output from the labeling error detection model M3 with the prior probability 40. For example, the labeling error detection unit 254b calculates the probability value based on Equation (2). In the second embodiment, the probability output from the labeling error detection model M3 is adjusted using the Bayesian definition.

$$[ Equation 3 ]$$

$$P ( O \vert {l}_{i} ) ≅ \frac{P ( {l}_{i} \vert O )}{P ( {l}_{i} )} \qquad ( 3 )$$

In Equation (3) , “0” is an input vector obtained from the phoneme boundary difference 31 and the phoneme boundary of the label without time information 242b. P(lᵢ|0) is a probability of the label lᵢ when an input vector is given, and is a probability output from the labeling error detection model M3. P(lᵢ) is the prior probability described in Equation (2).

For example, the labeling error detection unit 254b calculates a corrected first probability value obtained by correcting the first probability value by dividing the probability P(l₁|0) of the label l₁ by P(l₁). The labeling error detection unit 254b calculates a corrected second probability value obtained by correcting the second probability value by dividing the probability P(l₀|0) of the label l₀ by P(l₀).

When the corrected first probability value is larger than the corrected second probability value, the labeling error detection unit 254b classifies the label without time information 242b into a group in which the position of the phoneme boundary is appropriate.

On the other hand, when the second probability value is larger than the first probability value, the labeling error detection unit 254b classifies the label without time information 242b into a group in which the position of the phoneme boundary is not appropriate.

As described above, when the forward labeling unit 251, the backward labeling unit 252, and the detection unit 254 of the control unit 250 operate at the time of detection, the plurality of labels without time information 242b are classified into a group in which the position of the phoneme boundary is appropriate and a group in which the position of the phoneme boundary is not appropriate. The detection unit 254 may output the detection result to the output unit 230.

Next, effects of the labeling processing device 200 according to the second embodiment will be described. In the labeling processing device 200, the learning unit 253 calculates the prior probability 40 of the label on the basis of the labeling error detection label 35, and the detection unit 254 corrects the probability value output from the labeling error detection model M3 with the prior probability 40. As a result, even if a phoneme boundary difference that needs to be manually checked is input at the time of error label detection, it is possible to prevent erroneous detection of “appropriate (manual check is not necessary)”, and it is possible to improve determination accuracy regarding necessity of a manual check.

### EXAMPLE 3

In a third embodiment, when the labeling error detection model M3 is learned, the prior probability is used, so that it is possible to learn a labeling error detection model capable of appropriately calculating the first probability value and the second probability value even when the label “1” indicating that most of the labeling error detection labels are appropriate (manual check is not necessary) is provided.

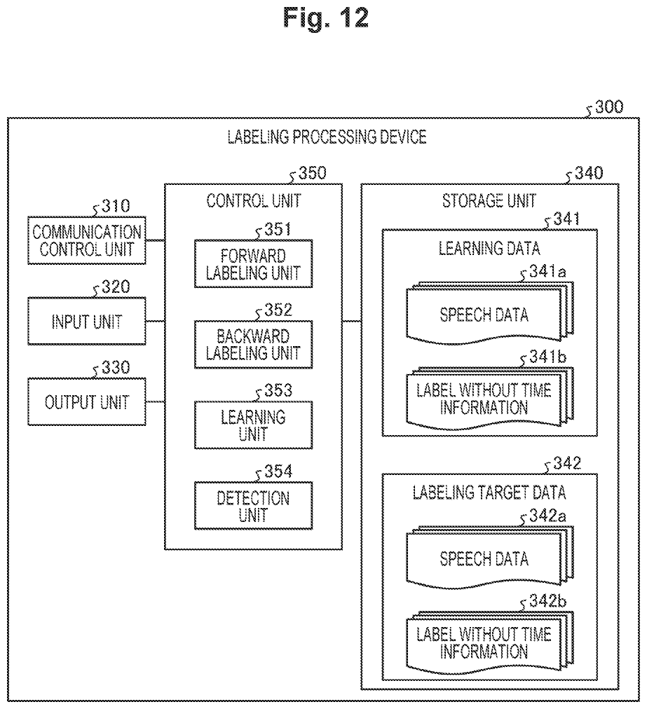

FIG. 12 is a functional block diagram illustrating a configuration of a labeling processing device according to the third embodiment. As illustrated in FIG. 12, a labeling processing device 300 includes a communication control unit 310, an input unit 320, an output unit 330, a storage unit 340, and a control unit 350.

The description regarding the communication control unit 310, the input unit 320, and the output unit 330 is similar to the description regarding the communication control unit 110, the input unit 120, and the output unit 130 described in the first embodiment.

The storage unit 340 includes learning data 341 and labeling target data 342. Here, the storage unit 340 is achieved by, for example, a semiconductor memory element such as a RAM or a flash memory, or a memory device such as a hard disk or an optical disk.

The learning data 341 includes speech data (a plurality of pieces of speech data) 341a and a label without time information (a plurality of labels without time information) 341b. The description of the speech data 341a and the label without time information 341b is similar to the description of the speech data 141a and the label without time information 141b described in the first embodiment.

The learning data 241 is used in processing at the time of learning by the control unit 250 described later.

The labeling target data 342 includes speech data (a plurality of pieces of speech data) 342a and a label without time information (a plurality of labels without time information) 342b. The description of the speech data 342a and the label without time information 342b is similar to the description of the speech data 142a and the label without time information 142b described in the first embodiment.

The control unit 350 includes a forward labeling unit 351, a backward labeling unit 352, a learning unit 353, and a detection unit 354. The control unit 350 corresponds to a CPU or the like.

First, after describing processing at the time of learning performed by the control unit 350, processing at the time of detection performed by the control unit 350 will be described.

At the time of learning, the forward labeling unit 351, the backward labeling unit 352, and the learning unit 353 of the control unit 350 operate. Processing of the forward labeling unit 351, the backward labeling unit 352, and the learning unit 353 at the time of learning will be sequentially described.

The processing of the forward labeling unit 351 and the backward labeling unit 352 at the time of learning is similar to the processing of the forward labeling unit 151 and the backward labeling unit 152 at the time of learning described in the first embodiment. The forward labeling unit 351 outputs a first label with time information 20 to the learning unit 353. The backward labeling unit 352 outputs a second label with time information 22 to the learning unit 353.

The learning unit 353 calculates a “prior probability” from a frequency at which “1 (manual check is not necessary)” is provided to the labeling error detection label and a frequency at which “0 (manual check is necessary)” is provided, as similar to the second embodiment.

The learning unit 353 learns a labeling error detection model that detects whether a phoneme boundary is appropriate on the basis of the prior probability and a difference between time information on a plurality of phoneme boundaries included in the first label with time information 20 and a plurality of phoneme boundaries included in the second label with time information 22.

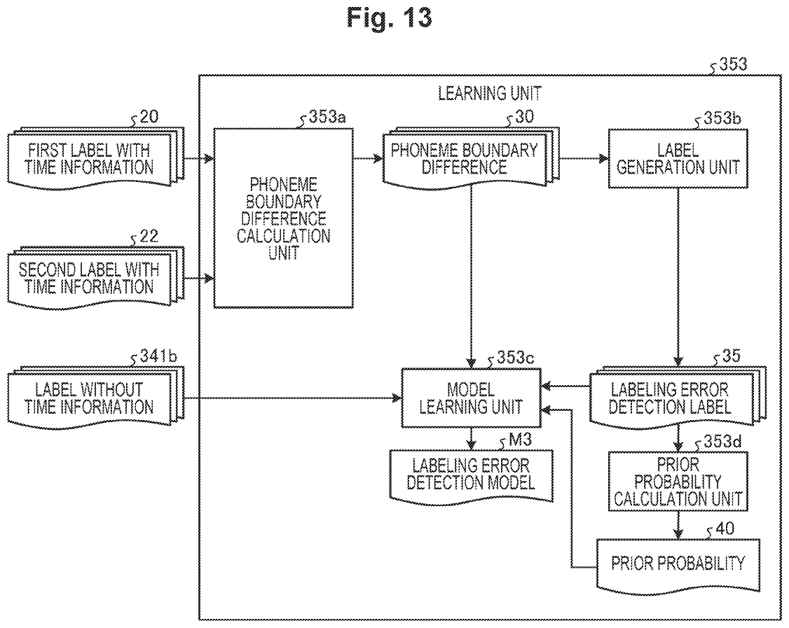

FIG. 13 is a diagram illustrating a configuration of a learning unit according to the third embodiment. As illustrated in FIG. 13, the learning unit 353 includes a phoneme boundary difference calculation unit 353a, a label generation unit 353b, a model learning unit 353c, and a prior probability calculation unit 353d.

The phoneme boundary difference calculation unit 353a calculates a difference (phoneme boundary difference 30) between time information on a plurality of phoneme boundaries included in the first label with time information 20 and a plurality of phoneme boundaries included in the second label with time information 22. Other descriptions of the phoneme boundary difference calculation unit 353a are similar to those of the phoneme boundary difference calculation unit 153a described in the first embodiment.

The label generation unit 353b determines whether the position of the phoneme boundary is appropriate for each phoneme boundary on the basis of the phoneme boundary difference 30, and provides a binary determination result to each phoneme boundary on the basis of the determination result, thereby generating the labeling error detection label 35. For example, the label generation unit 353b provides the label “1” to the phoneme boundary when the position of the phoneme boundary is appropriate, and provides the label “0” to the phoneme boundary when the position of the phoneme boundary is not appropriate. Other descriptions of the label generation unit 353b are similar to those of the label generation unit 153b described in the first embodiment.

The prior probability calculation unit 353d calculates a prior probability 40 on the basis of an appearance frequencies of the labels “1” and “0” provided to the labeling error detection label 35. Other descriptions of the prior probability calculation unit 353d are similar to those of the prior probability calculation unit 253d described in the second embodiment.

The model learning unit 353c performs learning of a labeling error detection model M3 on the basis of the phoneme boundary difference 30, the label without time information 341b, the labeling error detection label 35, and the prior probability 40.

For example, the model learning unit 353c learns the parameters of the labeling error detection model M3 that minimizes the cross entropy shown in Equation (4). When comparing Equations (1) and (4) described in the first embodiment, “1/P(l₁)” is added to Equation (4).

$$[ Equation 4 ]$$

$${loss ( O , {l}_{i} )}^{′} = - log ( \frac{exp ( P ( {l}_{i} \vert O ) )}{exp ( P ( {l}_{1} \vert O ) ) + exp ( {l}_{0} \vert O )} ) \times \frac{1}{P ( {l}_{i} )} \qquad ( 4 )$$

When the labeling error detection model M3 is learned using Equation (1) as in the first embodiment, the probability value of the label l₀ having a low appearance frequency in the learning data tends to be reduced. Therefore, the learning of the labeling error detection model M3 is performed using Equation (4) so as to put much emphasis on the label l₀ and put less emphasis on the label l₁ using the prior probability P(lᵢ). In a case where the appearance frequencies of the labels l₁ and l₀ are greatly different, data of a label having a small learning data amount is excessively prioritized, and thus scaling may be performed by taking a logarithm of P(lᵢ) or the like.

As described above, at the time of learning, the forward labeling unit 351, the backward labeling unit 352, and the learning unit 353 of the control unit 350 operate, and thereby, the learning of the labeling error detection model M3 ends.

Subsequently, processing at the time of detection performed by the control unit 350 will be described. At the time of detection, the forward labeling unit 351, the backward labeling unit 352, and the detection unit 354 of the control unit 350 operate. Processing of the forward labeling unit 351, the backward labeling unit 352, and the detection unit 354 at the time of detection will be sequentially described.

The processing of the forward labeling unit 351 and the backward labeling unit 352 at the time of detection is similar to the processing of the forward labeling unit 151 and the backward labeling unit 152 at the time of learning described in the first embodiment. The forward labeling unit 351 outputs a third label with time information 21 to the detection unit 354. The backward labeling unit 352 outputs a fourth label with time information 23 to the detection unit 354.

The detection unit 354 calculates a difference between time information on a plurality of phoneme boundaries included in the third label with time information 21 and a plurality of phoneme boundaries included in the fourth label with time information 23. The detection unit 254 inputs the input data based on the calculated difference and the label without time information 142b to the labeling error detection model M3, and determines whether the position of the phoneme boundary included in the label without time information 342b is appropriate. The other processing related to the detection unit 354 is similar to the processing of the detection unit 154 described in the first embodiment.

As described above, when the forward labeling unit 351, the backward labeling unit 352, and the detection unit 354 of the control unit 350 operate at the time of detection, the plurality of labels without time information 342b are classified into a group in which the position of the phoneme boundary is appropriate and a group in which the position of the phoneme boundary is not appropriate. The detection unit 354 may output the detection result to the output unit 330.

Next, effects of the labeling processing device 300 according to the third embodiment will be described. In the labeling processing device 300, when the labeling error detection model M3 is learned, the prior probability 40 is used, so that it is possible to learn the labeling error detection model M3 capable of appropriately calculating the first probability value and the second probability value even when the label “1” indicating that most of the labeling error detection labels are appropriate (manual check is not necessary) is provided.

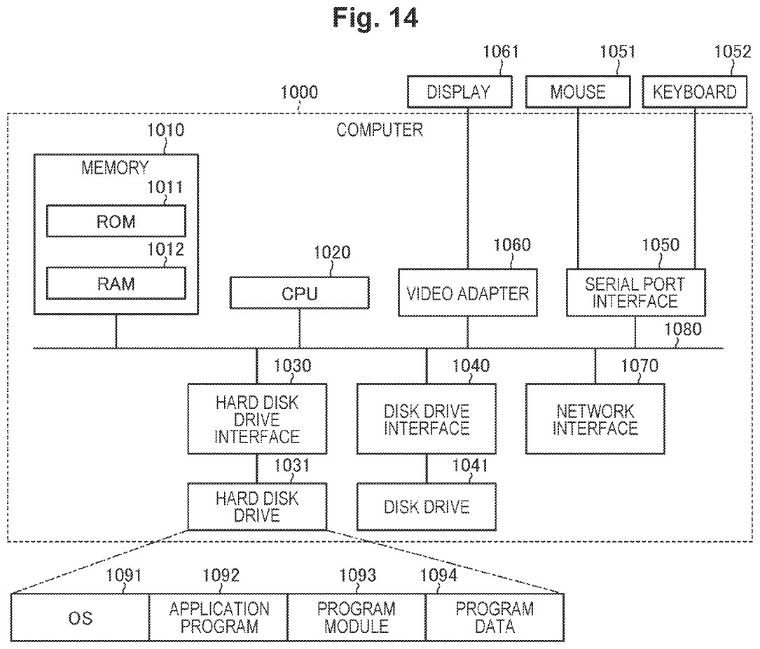

FIG. 14 is a diagram illustrating an example of a computer that executes a labeling processing program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. A mouse 1051 and a keyboard 1052, for example, are connected to the serial port interface 1050. A display 1061 is connected to, for example, the video adapter 1060.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

The labeling processing program is stored in the hard disk drive 1031, for example, as the program module 1093 in which commands to be executed by the computer 1000 are described. Specifically, the program module 1093 in which each process executed by the labeling processing device 100 (200, 300) described in the embodiments is described is stored in the hard disk drive 1031.

Data to be used for information processing performed by the labeling processing program is stored as the program data 1094, for example, in the hard disk drive 1031. The CPU 1020 reads, into the RAM 1012, the program module 1093 and the program data 1094 stored in the hard disk drive 1031 as necessary, and executes each procedure described above.

The program module 1093 and the program data 1094 related to the display control program are not limited to a case of being stored in the hard disk drive 1031, and may be stored in, for example, a removable storage medium and read by the CPU 1020 via the disk drive 1041 or the like. Alternatively, the program module 1093 and the program data 1094 related to the display control program may be stored in another computer connected via a network such as a LAN or a wide area network (WAN), and may be read by the CPU 1020 via the network interface 1070.

Although the embodiments to which the invention made by the present inventor is applied have been described above, the present invention is not limited by the description and the drawings as a part of the disclosure of the present invention according to the embodiments. In other words, other embodiments, examples, operation techniques, and the like made by those skilled is the art and the like on the basis of the embodiments are all included in the scope of the present invention.

### REFERENCE SIGNS LIST

100, 200, 300 Labeling processing device
110, 210 Communication control unit
120, 220 Input unit
130, 230 Output unit
140, 240 Storage unit
141, 241, 341 Learning data
141a, 241a, 341a Speech data
141b, 241b, 341b Label without time information
142, 242, 342 Labeling target data
150, 250, 350 Control unit
151, 251, 351 Forward labeling unit
151a, 152a Acoustic feature amount calculation unit
151b Time information calculation unit
152 Backward labeling unit
152b Acoustic feature amount inversion unit
152c First label inversion unit
152d Time information calculation unit
152e Second label inversion unit
153 Learning unit
153a, 154a, 253a, 254a, 353a Phoneme boundary difference calculation unit
153b, 253b, 353b Model generation unit
153c, 253c, 353c Model learning unit
154, 254, 354 Detection unit
154b, 254b Labeling error detection unit
253d, 353d Prior probability calculation unit

1. A labeling processing method comprising:
a forward labeling step comprising: generating first label information by labeling time information in a forward direction according to a plurality of phoneme boundaries set in speech information for learning;
a backward labeling step comprising: generating second label information by labeling time information in a direction opposite to the forward direction according to the plurality of phoneme boundaries set in the speech information for learning; and inverting an order of the time information that has been labeled; and
a learning step comprising: learning a model that detects whether the phoneme boundaries are appropriate based on a difference between time information of a plurality of phoneme boundaries included in the first label information and time information of a plurality of phoneme boundaries included in the second label information.

2. The labeling processing method according to claim 1,
wherein the forward labeling step further comprises: generating third label information by labeling time information in the forward direction according to a plurality of phoneme boundaries set in speech information as a detection target, and the backward labeling step further comprises: generating fourth label information by labeling time information in the direction opposite according to the plurality of phoneme boundaries set in the speech information as the detection target, and inverting an order of the time information that has been labeled,
the labeling processing method further comprising:
a detection step comprising: when a difference between time information of a plurality of phoneme boundaries in the fourth label information and the plurality of phoneme boundaries set in the speech information as the detection target are input to the model, detecting whether the phoneme boundaries set in the speech information as the detection target are appropriate based on an output result.

3. The labeling processing method according to claim 2, wherein
the learning step further comprises, when the difference is smaller than a threshold, determining that the plurality of phoneme boundaries set in the speech information for learning are appropriate,
the labeling processing method further comprises:
a calculation step comprising calculating, based on a determination result of the learning step, a prior probability, wherein the prior probability indicates:
a probability that the phoneme boundary is determined to be appropriate, and
a probability that the phoneme boundary is determined to be not appropriate, and
the detection step further comprises adjusting the output result based on the prior probability.

4. The labeling processing method according to claim 3, wherein, in the learning step, the model is learned by further using the prior probability.

5. A labeling processing device comprising a processor configured to execute operations comprising:
generating first label information by labeling time information in a forward direction according to a plurality of phoneme boundaries set in speech information for learning;
generating second label information by labeling time information in a direction opposite to the forward direction according to the plurality of phoneme boundaries set in the speech information for learning and inverting an order of the time information that has been labeled; and
learning a model that detects whether the phoneme boundaries set in the speech information are appropriate based on a difference between time information of a plurality of phoneme boundaries included in the first label information and time information of a plurality of phoneme boundaries included in the second label information.

6. A computer-readable non-transitory recording medium storing computer-executable program instructions that when executed by a processor cause a computer system to execute operations comprising:
a forward labeling step comprising: generating first label information by labeling time information in a forward direction according to a plurality of phoneme boundaries set in speech information for learning;
a backward labeling step comprising: generating second label information by labeling time information in a direction opposite to the forward direction according to the plurality of phoneme boundaries set in the speech information for learning; and inverting an order of the time information that has been labeled; and
a learning step comprising: learning a model that detects whether the phoneme boundaries are appropriate based on a difference between time information of a plurality of phoneme boundaries included in the first label information and time information of a plurality of phoneme boundaries included in the second label information.

7. The labeling processing device according to claim 5,
wherein generating the first label information further comprises: generating third label information by labeling time information in the forward direction according to a plurality of phoneme boundaries set in speech information as a detection target, and the backward labeling step further comprises: generating fourth label information by labeling time information in the direction opposite according to the plurality of phoneme boundaries set in the speech information as the detection target, and inverting an order of the time information that has been labeled,
the processor further configured to execute operations comprising:
a detection step comprising: when a difference between time information of a plurality of phoneme boundaries in the fourth label information and the plurality of phoneme boundaries set in the speech information as the detection target are input to the model, detecting whether the phoneme boundaries set in the speech information as the detection target are appropriate based on an output result.

8. The labeling processing device according to claim 7,
wherein
learning further comprises, when the difference is smaller than a threshold, determining that the plurality of phoneme boundaries set in the speech information for learning are appropriate,
the labeling processing method further comprises:
a calculation step comprising calculating, based on a determination result of the learning step, a prior probability, wherein the prior probability indicates:
a probability that the phoneme boundary is determined to be appropriate, and
a probability that the phoneme boundary is determined to be not appropriate, and
the detection step further comprises adjusting the output result based on the prior probability.

9. The labeling processing device according to claim 8, wherein the learning further comprises learning the model using the prior probability.

10. The computer-readable non-transitory recording medium according to claim 6,
wherein the forward labeling step further comprises: generating the first label information further comprises: generating third label information by labeling time information in the forward direction according to a plurality of phoneme boundaries set in speech information as a detection target, and the backward labeling step further comprises: generating fourth label information by labeling time information in the direction opposite according to the plurality of phoneme boundaries set in the speech information as the detection target, and inverting an order of the time information that has been labeled,
the computer-executable program instructions when executed further causing the computer system to execute operations comprising:
a detection step comprising: when a difference between time information of a plurality of phoneme boundaries in the fourth label information and the plurality of phoneme boundaries set in the speech information as the detection target are input to the model, detecting whether the phoneme boundaries set in the speech information as the detection target are appropriate based on an output result.

11. The computer-readable non-transitory recording medium according to claim 10,
wherein
the learning step further comprises, when the difference is smaller than a threshold, determining that the plurality of phoneme boundaries set in the speech information for learning are appropriate,
the computer-executable program instructions when executed further causing the computer system to execute operations comprising:
a calculation step comprising calculating, based on a determination result of the learning step, a prior probability, wherein the prior probability indicates:
a probability that the phoneme boundary is determined to be appropriate, and
a probability that the phoneme boundary is determined to be not appropriate, and
the detection step further comprises adjusting the output result based on the prior probability.

12. The computer-readable non-transitory recording medium according to claim 11, wherein, in the learning step, the model is learned by further using the prior probability.
